(19) United States
(12) Patent Application Publication
(10) Pub. No.: US 2008/0251771 A1
(43) Pub. Date: Oct. 16, 2008

(54) Coating Material, Method for the Production and Use Thereof, for Producing Adhesive, Corrosion-Inhibiting Coatings

(75) Inventors: Allard Maxime, Dachstein (FR); Kauffer Dominique, Drensteinfurt (FR)

Correspondence Address: Mary E. Golota;Cantor Colburn LLP, 201 W. Big Beaver Road, Suite 1101, Troy, MI, 48084, US

(73) Assignee: BASF COATINGS AKTIENGESELLSCHAFT, Munster (DE)

(21) Appl. No.: 11/913,679

(22) PCT Filed: May 3, 2006
(86) PCT No.: PCT/EP06/61991

§ 371 Date: Jun. 6, 2008

(30) Foreign Application Priority Data
May 6, 2005 (DE) 10 2005 021 086.4

(51) Int. Cl. H01B 1/12; C08G 63/02; C08K 3/32

(52) U.S. Cl. 252/519.33; 524/612; 252/500; 524/599; 524/417

(57) ABSTRACT

A liquid coating material curable with actinic radiation, substantially or entirely free from organic solvents and comprising

(A) at least two compounds of the general formula I:

X—O—Y(—OH)-Z-Gr, (I)

in which the variables have the following definitions:
X is aromatic radical having 6 to 14 carbon atoms, heterocyclic aromatic radical having 5 to 20 ring atoms or alkyl radical having 6 to 30 carbon atoms,
Y is trivalent organic radical,
Z is linking functional group, and
Gr is organic radical having at least one group which can be activated with actinic radiation;
   with the proviso that at least one of the at least two compounds (A) contains an aromatic or heterocyclic aromatic radical X (=compound A1) and at least one of the at least two compounds (A) contains an alkyl radical X (=compound A2);

(B) at least one acidic, corrosion-inhibiting pigment based on polyphosphoric acid, and

(C) at least one constituent selected from the group consisting of nanoparticles and electrically conductive pigments;

process for preparing it, and its use.

### FIELD OF THE INVENTION

The present invention relates to a new coating material curable with actinic radiation. The present invention also relates to a new process for preparing a coating material curable with actinic radiation. The present invention further relates to the use of the new coating material or of the coating material prepared by means of the new process to produce thermally adhering, corrosion-inhibiting coatings, particularly coil coatings, especially primer coats.

### PRIOR ART

In order to produce thermally adhering, corrosion-inhibiting coatings on metal strips or coils, particularly those made from the conventional utility methods, such as zinc, aluminum or bright, galvanized, electrolytically zincked, and phosphated steel, by means of the coil coating process (Römpp Lexikon Lacke und Druckfarben, Georg Thieme Verlag, Stuttgart, New York, 1998, page 617, “Roll coating”, and page 55, “Coil coating”) it is necessary to pretreat the surface of the metal coils. As part of the coil coating process, however, this represents an additional step, which it would be desirable to avoid on economic and technical grounds.

Primer coats serve, as is known, to promote adhesion between the metal surface and the coatings lying above it. To a certain extent they may also contribute to corrosion control. They are normally produced from pigmented, solventborne, thermally curable coating materials. However, this necessitates complex units for the suction withdrawal and disposal of the emitted solvents, and the coils must be heated to high temperatures (“peak metal temperatures”, PMT) in order to cure the applied coating materials at the speed which is necessary for the coil coating process. It is therefore highly desirable to have available solvent-free coating materials, rapidly curable with actinic radiation, for producing primer coats.

German patent application DE 102 56 265 Al discloses a liquid coating material which is curable with actinic radiation, is substantially or entirely free from organic solvents, is in the form of a water-in-oil dispersion, and has a pH <5, comprising
(A) at least one constituent selected from the group consisting of low molecular mass, oligomeric, and polymeric organic compounds containing at least one group which can be activated with actinic radiation, and also air-drying and oxidatively drying alkyd resins,
(B) at least one acidic ester of polyphosphoric acid and of at least one compound (b1) containing at least one hydroxyl group and at least one group which can be activated with actinic radiation,
(C) at least one acidic ester of monophosphoric acid and of at least one compound (c1) containing at least one hydroxyl group and at least one group which can be activated with actinic radiation, and
(D) at least one acidic, corrosion-inhibiting pigment based on polyphosphoric acid.

The coating material may further comprise at least one additive (E) which may be selected preferably from the group consisting of polyphosphoric acid, driers, non-(D), organic and inorganic, colored and achromatic, optical effect, electrically conductive, magnetically shielding, and fluorescent pigments, transparent and opaque, organic and inorganic fillers, nanoparticles, antisettling agents, non-(A) oligomeric and polymeric binders, UV absorbers, light stabilizers, free-radical scavengers, photoinitiators, devolatilizers, slip additives, polymerization inhibitors, defoamers, non-(C) emulsifiers and wetting agents, adhesion promoters, leveling agents, film-forming assistants, rheology control additives, and flame retardants.

The known coating material is easily to prepare, of high reactivity and yet good storage stability, can be applied easily and without problems, particularly in the coil coating process, and can be cured rapidly at low curing temperatures without emitting volatile organic compounds. It yields coatings, particularly coil coatings, especially primer coatings, which, even on unpretreated metal surfaces, particularly the surface of utility metals, such as zinc, aluminum or bright, galvanized, electrolytically zincked, and phosphated steel, have high adhesion, high intercoat adhesion with respect to the coatings lying above them, and an outstanding corrosion control effect, particularly with respect to white corrosion.

The continually growing requirements of the market, particularly those of the manufacturers of coated coils and their customers, however, necessitate further development of this existing technical level in a wide variety of respects.

Where highly pigmented topcoats, topcoats with only slight gloss, or matt topcoats are to be produced, it is advisable for that purpose to use coating materials curable with actinic radiation, which can be cured rapidly preferably with electron beams (EBC) (cf., e.g., A. Goldschmidt and H.-J. Streitberger, BASF-Handbuch Lackiertechnik, Vincentz Verlag, Hannover, 2002, pages 638 to 641). Because of the high pigment content, curing with UV radiation is difficult if not impossible. It has emerged, however, that the primer coatings produced from the known coating material, by curing with EBC and under inert gas, do not attain the performance level of primer coatings produced by curing with UV radiation and heat. In particular they do not achieve the requisite direct adhesion to unpretreated metal surfaces and the requisite intercoat adhesion to the highly pigmented topcoats.

### Problem Addressed

It is an object of the present invention to provide a new, pigmented coating material which is curable with actinic radiation, is substantially or entirely free from organic solvents, and no longer exhibits the disadvantages of the prior art but instead is easy to prepare, highly reactive and yet stable on storage, can be applied particularly easily and without problems, particularly as part of the coil coating process, and can be cured very rapidly at low curing temperatures and without emitting volatile organic compounds, and yields coatings, particularly coil coatings, especially primer coatings, which, even on unpretreated metal surfaces, particularly the surface of utility metals, such as zinc, aluminum or bright, galvanized, electrolytically zincked, and phosphated steel, have particularly high adhesion, particularly high intercoat adhesion to the coatings lying above them, and an outstanding corrosion control effect, particularly with respect to white corrosion.

The advantageous profile of performance properties of the new coatings produced from the new coating material ought to be obtainable even when the coating material is cured by means of EBC, particularly under inert conditions.

The new coating material ought additionally to allow the production of new, electrically conductive, weldable coatings of outstanding corrosion control effect which are free from zinc or from iron phosphides. In this context the substitution of the iron phosphides in particular would be a particular advantage, since, on account of their high hardness, this class of electrically conductive pigments cause mechanical damage, particularly through abrasion, to the equipment during the preparation of coating materials in question. The new, electrically conductive, weldable coatings ought to be able to be coated directly, without subsequent heat curing, with electrocoat materials.

The new coatings ought, furthermore, to have particularly high flexibility and hardness.

### Solution Found

Found accordingly has been the new coating material curable with actinic radiation, substantially or entirely free from organic solvents and comprising

(A) at least two compounds of the general formula I:

X—O—Y(—OH)-Z-Gr (I),

in which the variables have the following definitions:
X is aromatic radical having 6 to 14 carbon atoms, heterocyclic aromatic radical having 5 to 20 ring atoms or alkyl radical having 6 to 30 carbon atoms,
Y is trivalent organic radical,
Z is linking functional group, and
Gr is organic radical having at least one group which can be activated with actinic radiation;
   with the proviso that at least one of the at least two compounds (A) contains an aromatic or heterocyclic aromatic radical X (=compound A1) and at least one of the at least two compounds (A) contains an alkyl radical X (=compound A2);

(B) at least one acidic, corrosion-inhibiting pigment based on polyphosphoric acid, and

(C) at least one constituent selected from the group consisting of nanoparticles and electrically conductive pigments.

The new coating material is referred to below as “coating material of the invention”.

Also found has been the new process for preparing the coating material of the invention, which involves mixing constituents (A), (B) and (C) and also, where used, (D) of the coating material with one another and homogenizing the resulting mixture.

The new process is referred to below as “process of the invention”.

Further inventions will emerge from the description.

In the light of the prior art it was surprising and unforeseeable for the skilled worker that the object on which the present invention was based could be achieved by means of the coating material of the invention and by means of the process of the invention.

In particular it was surprising that the coating material of the invention no longer had the disadvantages of the prior art but instead was easy to prepare, highly reactive and yet stable on storage, could be applied particularly easily and without problems, particularly as part of the coil coating process, and could be cured very rapidly at particularly low curing temperatures and without emitting volatile organic compounds, and yielded new coatings, particularly coil coatings, especially primer coatings, which, even on unpretreated metal surfaces, particularly the surface of utility metals, such as zinc, aluminum or bright, galvanized, electrolytically zincked, and phosphated steel, had particularly high adhesion, particularly high intercoat adhesion to the coatings lying above them, and an outstanding corrosion control effect, particularly with respect to white corrosion.

The advantageous profile of performance properties of the coatings of the invention produced from the coating material of the invention was obtained even when the coating material of the invention was cured by means of EBC, particularly under inert conditions.

The coating material of the invention also allowed the production of new, electrically conductive, weldable coatings of outstanding corrosion control effect which were free from zinc or from iron phosphides. In this context the substitution of the iron phosphides in particular, was a particular advantage, since, on account of their high hardness, this class of electrically conductive pigments caused mechanical damage, particularly by abrasion, to the equipment during the preparation of the coating materials in question. The electrically conductive, weldable coatings of the invention could be coated directly, without subsequent heat curing, with electrocoat materials.

Furthermore, the coatings of the invention had particularly high flexibility and hardness.

### DETAILED DESCRIPTION OF THE INVENTION

The coating material of the invention is liquid, i.e., although it comprises solid, non-liquid constituents, it is nevertheless in a fluid state at room temperature under the conventional conditions of preparation, storage, and application, and so can be processed by means of the conventional application methods employed in the coil coating process.

The coating material of the invention is preferably in the form of a water-in-oil dispersion, in which the discontinuous aqueous phase is finely dispersed in the continuous organic phase. The diameter of the droplets of the aqueous phase may vary widely; preferably it is 10 nm to 1000 μm, in particular 100 nm to 800 μm. The constituents of the coating material of the invention are divided between the aqueous phase and organic phase in accordance with their hydrophilicity or hydrophobicity (cf. Römpp Online, 2002, “hydrophobicity”, “hydrophilicity”) or in the form of a separate solid phase.

The coating material of the invention, or its aqueous phase, has as a water-in-oil dispersion a pH of preferably <5, more preferably <4, and in particular from 3 to 3.5.

The coating material of the invention is substantially or entirely free from organic solvents. This means that its organic solvent content is <5%, preferably <3%, and more preferably <1% by weight. In particular the content is below the detection limits of the conventional qualitative and quantitative detection methods for organic solvents.

The coating material of the invention comprises at least two, in particular two, compounds of the general formula I:

X—O—Y(—OH)-Z-Gr (I).

In this formula the variables have the following definitions:
X is aromatic radical having 6 to 14, preferably 6 to 10, carbon atoms, heterocyclic aromatic radical having 5 to 20, preferably 6 to 10, ring atoms or alkyl radical having 6 to 30, preferably 8 to 20, particularly 10 to 16, carbon atoms; preferably aromatic radical having 6 to 10 carbon atoms or alkyl radical having 10 to 16 carbon atoms; particularly phenyl radical or lauryl radical;
Y is trivalent organic radical, preferably aliphatic radical, preferably aliphatic radical having 3 carbon atoms, particularly 1,2,3-propanetriyl;
Z is linking functional group, preferably selected from the group consisting of ether, thioether, carboxylic ester, thiocarboxylic ester, carbonate, thiocarbonate, phosphoric ester, thiophosphoric ester, phosphonic ester, thiophosphonic ester, phosphite, thiophosphite, sulfonic ester, amide, amine, thioamide, phosphoramide, thiophosphoramide, phosphonamide, thiophosphonamide, sulfonamide, imide, urethane, hydrazide, urea, thiourea, carbonyl, thiocarbonyl, sulfone, sulfoxide or siloxane groups. Preferred among these groups are the ether, carboxylic ester, carbonate, carboxamide, urea, urethane, imide and carbonate groups, preferably carboxylic ester group, and particularly carboxylic ester group linked to the radicals Y and Gr in accordance with the general formula II:

>Y—O—(O═)C-Gr (II),

and
Gr is organic radical having at least one, especially one, group which can be activated with actinic radiation;
   with the proviso that at least one, especially one, of the at least two, especially two, compounds (A) contains an aromatic or heterocyclic aromatic, especially aromatic, radical X (=compound A1) and at least one, especially one, of the at least two, especially two, compounds (A) contains an alkyl radical X (=compound A2).

Actinic radiation means electromagnetic radiation, such as near infrared (NIR), visible light, UV radiation, X-rays or gamma radiation, preferably UV radiation, and corpuscular radiation, such as electron beams, alpha radiation, beta radiation, proton beams or neutron beams, preferably electron beams. In particular the actinic radiation constitutes electron beams.

The groups which can be activated with actinic radiation contain at least one, especially one, bond which can be activated with actinic radiation. By this is meant a bond which, when subjected to actinic radiation, becomes reactive and, together with other activated bonds of its kind, enters into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single bonds or double bonds, or carbon-carbon triple bonds. Of these, the carbon-carbon double bonds and triple bonds are advantageous and are therefore used with preference in accordance with the invention. The carbon-carbon double bonds are particularly advantageous, and so are used with particular preference. For the sake of brevity they are referred to below as “double bonds”.

The double bonds are preferably present in organic radicals Gr of the general formula III:

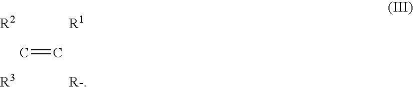

In the general formula III the variables have the following definitions:
R is single bond to an atom of the above-described linking functional group Z, particularly carbon-carbon single bond to the carbon atom of a carbonyloxy group and divalent organic radical, preferably carbon-carbon single bond; and
R¹, R²
and R³ are hydrogen atom and organic radical;
   it being possible for at least two of the radicals R, R¹, R² and R³ to be cyclically linked to one another.

Examples of suitable divalent organic radicals R comprise or consist of alkylene, cycloalkylene and/or arylene groups. Highly suitable alkylene groups contain one carbon atom or 2 to 6 carbon atoms. Highly suitable cycloalkylene groups contain 4 to 10, particularly 6, carbon atoms. Highly suitable arylene groups contain 6 to 10, particularly 6, carbon atoms.

Examples of suitable organic radicals R¹, R², and R³ comprise or consist of alkyl, cycloalkyl and/or aryl groups. Highly suitable alkyl groups contain one carbon atom or 2 to 6 carbon atoms. Highly suitable cycloalkyl groups contain 4 to 10, particularly 6, carbon atoms. Highly suitable aryl groups contain 6 to 10, particularly 6, carbon atoms.

The organic radicals R, R¹, R², and R³ may be substituted or unsubstituted. The substituents, however, must not disrupt the implementation of the process of the invention and/or inhibit the activation of the groups with actinic radiation. Preferably the organic radicals R, R¹, R², and R³ are unsubstituted.

Examples of particularly suitable radicals Gr of the general formula III are vinyl, 1-methylvinyl, 1-ethylvinyl, propen-1-yl, styryl, cyclohexenyl, endomethylenecyclohexyl, norbornenyl, and dicyclopentadienyl groups, especially vinyl groups.

Accordingly the particularly preferred radicals of the general formula (IV)

-Z-Gr (IV)

are (meth)acrylate, ethacrylate, crotonate, cinnamate, cyclohexenecarboxylate, endomethylenecyclohexanecarboxylate, norbornenecarboxylate, and dicyclopentadienecarboxylate groups, preferably (meth)acrylate groups, especially acrylate groups.

Examples of particularly advantageous compounds (A1) are phenyl glycidyl ether monoacrylates, as sold, for example, by Cray Valley under the name Aromatic Epoxy Acrylate CN 131B.

Examples of particularly advantageous compounds (A2) are lauryl glycidyl ether monoacrylates, such as are sold, for example, by Cray Valley under the name Aliphatic Epoxy Acrylate Monofunctional CN152.

The amount of the compounds (A) in the coating material of the invention may vary widely and is guided by the requirements of the case in hand. Preferably the amount of the compounds (A1), based in each case on the coating material of the invention, is 10% to 60%, preferably 15% to 50%, and in particular 20% to 40% by weight. The amount of the compounds (A2), based in each case on the coating material of the invention, is preferably 5% to 50%, more preferably 10% to 40%, and in particular 15% to 30% by weight. The weight ratio of (A1) to (A2) is preferably 4:1 to 0.8:1, more preferably 3:1 to 1.2:1, very preferably 2:1 to 1.2:1, and in particular 1.6:1 to 1.4:1.

The coating material of the invention comprises at least one, especially one, acidic corrosion-inhibiting pigment (B) based on polyphosphoric acid. Preference is given to using aluminum polyphosphates and zinc polyphosphates, especially aluminum polyphosphates. Aluminum polyphosphates are conventional products and are sold, for example, under the brand name Targon® by BK Giulini.

The amount of the pigment (B) in the coating material of the invention may vary very widely and is guided by the requirements of the case in hand. The amount of pigment (B), based in each case on the coating material of the invention, is preferably 1% to 60%, more preferably 4% to 50%, and in particular 5% to 40% by weight.

The coating material of the invention further comprises at least one constituent (C) selected from the group consisting of nanoparticles and electrically conductive pigments.

As nanoparticles (C) use is made of at least one, especially one, kind of nanoparticles. It is preferred to use inorganic nanoparticles (C).

The nanoparticles (C) are preferably selected from the group consisting of main-group metals and transition-group metals and their compounds. The main-group and transition-group metals are preferably selected from metals of main groups three to five, transition groups three to six, and transition groups one and two of the Periodic Table of the Elements, and also the lanthanides. Particular preference is given to using boron, aluminum, gallium, silicon, germanium, tin, arsenic, antimony, silver, zinc, titanium, zirconium, hafnium, vanadium, niobium, tantalum, molybdenum, tungsten, and cerium, especially aluminum, silicon, silver, cerium, titanium, and zirconium.

The compounds of the metals are preferably the oxides, oxide hydrates, sulfates or phosphates.

Preference is given to silver, silicon dioxide, aluminum oxide, aluminum oxide hydrate, titanium dioxide, zirconium oxide, cerium oxide, and mixtures thereof; particular preference to silver, cerium oxide, silicon dioxide, aluminum oxide hydrate, and mixtures thereof; very particular preference to silicon dioxide; and a special preference to pyrogenic silicon dioxide (fumed silica).

The nanoparticles (C) have a primary particle size of preferably <50 nm, more preferably 5 to 50 nm, in particular 10 to 30 nm.

The electrically conductive pigment (C) is preferably selected from the group consisting of metal-doped oxides of zinc, tin, indium, and antimony, preferably from indium-tin oxide, aluminum-zinc oxide, titanium-tin oxide, Antimon-Antimonoxid and antimony-tin oxide. The electrically conductive pigment (C) may also be a nanoscale pigment.

The amount of the constituents (C) in the coating material of the invention is preferably 1% to 60%, more preferably 4% to 50%, and in particular 5% to 40% by weight, based in each case on the coating material of the invention.

The coating material of the invention may further comprise at least one additive (D) in effective amounts. The additive (D) is preferably selected from the group consisting of water, polyphosphoric acid, phosphonic acids having at least one group which can be activated with actinic radiation, acidic esters of polyphosphoric acid and of at least one compound containing at least one hydroxyl group and at least one group which can be activated with actinic radiation, acidic esters of monophosphoric acid and of at least one compound containing at least one hydroxyl group and at least one group which can be activated with actinic radiation, compounds having at least one group which can be activated with actinic radiation, other than the compounds (A), driers, non-(C), organic and inorganic, colored and achromatic, optical effect, electrically conductive, magnetically shielding, and fluorescent pigments, transparent and opaque, organic and inorganic fillers, nanoparticles, oligomeric and polymeric binders, UV absorbers, light stabilizers, free-radical scavengers, photoinitiators, devolatilizers, slip additives, polymerization inhibitors, defoamers, emulsifiers and wetting agents, adhesion promoters, leveling agents, film-forming assistants, rheology control additives, and flame retardants.

Preferably the additive (D) is selected from the group consisting of water; polyphosphoric acid; phosphonic acids having at least one group which can be activated with actinic radiation, especially vinylphosphonic acid; and also acidic esters of polyphosphoric acid and of at least one compound containing at least one hydroxyl group and at least one group which can be activated with actinic radiation, and acidic esters of monophosphoric acid and at least one compound containing at least one hydroxyl group and at least one group which can be activated with actinic radiation, such as are described, for example, in German patent application DE 102 56 265 A1, page 7, paragraphs [0057] to [0062], in conjunction with page 6, paragraphs [0044] and [0045]. Water is preferably used in an amount of 1% to 10%, more preferably 2% to 8%, and in particular 3% to 7% by weight, based in each case on the coating material of the invention. The phosphonic acids and the acidic esters of monophosphoric acid and polyphosphoric acid are used preferably in an amount of 0.05% to 5%, preferably 0.5% to 4%, and in particular 1% to 3% by weight, based in each case on the coating material of the invention.

The coating material of the invention is prepared preferably by mixing the above-described constituents in suitable mixing apparatus such as stirred tanks, agitator mills, extruders, compounders, Ultraturrax devices, inline dissolvers, static mixers, micromixers, toothed-wheel dispersers, pressure release nozzles and/or microfluidizers. It is preferred here to work in the absence of light with a wavelength λ<550 nm or in the complete absence of light, in order to prevent premature crosslinking of the constituents containing groups which can be activated with actinic radiation.

The coating materials of the invention are outstandingly suitable for producing coatings of all kinds. They are particularly suitable for use as coil coating materials. Additionally they are outstandingly suitable for producing coatings on all utility metals, particularly on bright steel, galvanized, electrolytically zincked, and phosphated steel, zinc, and aluminum, on coatings, especially primer coatings, and on SMC (Sheet Moulded Compounds) and BMC (Bulk Moulded Compounds). In this context, the coatings of the invention are outstandingly suitable for use as clearcoats, topcoats, temporary or permanent protective coats, primer coatings, seals, and antifingerprint coatings, but especially as primer coatings.

Surprisingly the coatings of the invention, particularly the primer coatings of the invention, even on unpretreated metal surfaces, such as on unpretreated HDG (hot dip galvanized) steel, meet at least the requirements of class IV of the Usinor specification for components for outdoor use, particularly in respect of adhesion, flexibility, hardness, chemical resistance, intercoat adhesion, and corrosion control effect, in full.

In terms of method the application of the coating material of the invention exhibits no particularities, but can instead take place by any customary application methods, such as spraying, knifecoating, brushing, flow coating, dipping, trickling or rolling, for example. Generally speaking, it is advisable to operate in the absence of actinic radiation, in order to prevent premature crosslinking of the coating materials of the invention. Following application, the water present in the coating material of the invention can be simply evaporated, also referred to as flash-off. This is preferably done by brief inductive heating of the metal substrates.

Particularly suitable for curing the applied coating materials of the invention with actinic radiation are electron beam sources, as described, for example, A. Goldschmidt and H.-J. Streitberger, BASF-Handbuch Lackiertechnik, Vincentz Verlag, Hannover, 2002, pages 638 to 641, or in Römpp Lexikon Lacke und Druckfarben, Georg Thieme Verlag, Stuttgart New York, 1998, “electron-beam emitters”, “electron-beam curing”, and “electron beams”.

For irradiation it is preferred to use a radiation dose of 10 to 200, preferably 20 to 100, and in particular 30 to 80 kGy (kilograys).

The radiation intensity may vary widely. It is guided in particular by the radiation dose on the one hand and the irradiation time on the other. The irradiation time is guided, for a given radiation dose, by the belt speed or advance rate of the substrates in the irradiation unit, and vice versa.

It is a particular advantage of the coating material of the invention that it can also be only part-cured and in said part-cured state can be overcoated with at least one further coating material, in particular with a coating material curable with actinic radiation, after which all of the applied films are cured jointly with actinic radiation. This further shortens the operating times, and further enhances the intercoat adhesion. Overall, by virtue of the use of the coating material of the invention, it is no longer necessary to heat the metal sheets to PMTs of 240° C. or more in the coil coating process. Also superfluous are the suction withdrawal and disposal of volatile organic compounds, thereby allowing significant reductions in the cost and complexity associated with apparatus, safety equipment, and energy.

The resultant coatings of the invention are highly flexible, can be deformed very greatly without damage, are resistant to chemicals, weathering, condensation, and salt water, and adhere very well to the substrates and to other coatings. In combination with all of these qualities, they also impart an outstanding visual impression. They can be overcoated without problems, after which the resulting composites or laminates have an outstanding intercoat adhesion.

### EXAMPLES

### Example 1

### The Preparation of Coating Material 1

To prepare coating material 1 first a mixture of 33.25 parts by weight of phenyl glycidyl ether monoacrylate (CN 131B from Cray Valley), 22.8 parts by weight of lauryl glycidyl ether monoacrylate (CN 152 from Cray Valley), 1.12 parts by weight of polypropylene glycol monoacrylate (PAM 300 from Rhodia), 1.12 parts by weight of an epoxy resin (Epikote® 862), 5.82 parts by weight of water, 2.91 parts by weight of a polyphosphoric ester of 4-hydroxybutyl acrylate (prepared by reacting 80 parts by weight of 4-hydroxybutyl acrylate and 20 parts by weight of polyphosphoric acid having a diphosphorus pentoxide content of 84% by weight; 4-hydroxybutyl acrylate excess: 20% by weight), 1.68 parts by weight of low-viscosity polyvinylbutyral (Pioloform® BN 18 from Wacker), 18.5 parts by weight of aluminum polyphosphate pigment (Targon® WA 2886 from BK Giulini), 6 parts by weight of nanoparticles based on silica (Nyasil® 6200 from Nyacol Nano Technologies), and 9 parts by weight of titanium dioxide pigment (Tioxide® TR 81) was prepared. The mixture was homogenized in an Ultraturrax at a rotational speed of 1800/min for 20 minutes.

Coating material 1 was fully stable on storage in the absence of actinic radiation for at least one month. It was outstandingly suitable for producing primer coatings.

### Example 2

### The Preparation of Coating Material 2

To prepare coating material 2 first a mixture of 28.7 parts by weight of phenyl glycidyl ether monoacrylate (CN 131B from Cray Valley), 19.14 parts by weight of lauryl glycidyl ether monoacrylate (CN 152 from Cray Valley), 0.957 parts by weight of polypropylene glycol monoacrylate (PAM 300 from Rhodia), 0.957 parts by weight of an epoxy resin (Epikote® 862), 4.78 parts by weight of water, 2.39 parts by weight of a polyphosphoric ester of 4-hydroxybutyl acrylate (prepared by reacting 80 parts by weight of 4-hydroxybutyl acrylate and 20 parts by weight of polyphosphoric acid having a diphosphorus pentoxide content of 84% by weight; 4-hydroxybutyl acrylate excess: 20% by weight), 9.57 parts by weight of aluminum polyphosphate pigment (Targon® WA 2886 from BK Giulini), and 33.5 parts by weight of an electrically conductive pigment based on a metal-doped oxide was prepared. The mixture was homogenized in an Ultraturrax at a rotational speed of 1800/min for 20 minutes.

Coating material 2 was fully stable on storage in the absence of actinic radiation for at least one month. It was outstandingly suitable for producing primer coatings.

### Examples 3 and 4

The Production of Primer Coatings Using Coating Materials 1 and 2 from Examples 1 and 2

The substrates used were unpretreated, HDG (hot dipped galvanized) steel panels from Chemetall.

In the case of Example 3, coating material 1 was applied in a film thickness of 6 to 7 μm. The water present therein was evaporated at 125° C. for one minute. The resulting film was cured with electron beams (50 kGy).

The resulting coating was outstandingly deformable and had an outstanding corrosion control effect (T-Bend test: 0, and tape: 0; salt water spray test: 7 days, satisfactory (sat.)). It could be overcoated with conventional topcoats. The resulting laminates exhibited outstanding intercoat adhesion and an outstanding corrosion control effect (salt water spray test: 21 days, sat.).

In the case of Example 4, coating material 2 was applied in a film thickness of 2 to 3 μm. The water present therein was evaporated at 120° C. for 30 seconds. The resulting film was cured with electron beams (50 kGy).

The resulting coating could be overcoated readily with electrocoat materials. In the course of the thermal curing thereof there is no blistering or other surface defects. The intercoat adhesion, deformability, and corrosion control effect were outstanding (T-Bend test: 0, and tape: 0.5; salt water spray test: 120 hours, sat.).

1. A coating material curable with actinic radiation, substantially or entirely free from organic solvents and comprising
(A) at least two compounds of the general formula I:
X—O—Y(—OH)—Z-Gr (I),
wherein
X is an aromatic radical having 6 to 14 carbon atoms, a heterocyclic aromatic radical having 5 to 20 ring atoms or an alkyl radical having 6 to 30 carbon atoms,
Y is a trivalent organic radical,
Z is a linking functional group, and
Gr is an organic radical comprising at least one group which can be activated with actinic radiation;
with the proviso that at least one compound (A1) of the at least two compounds (A) comprises an aromatic or heterocyclic aromatic radical X and at least one compound (A2) of the at least two compounds (A) comprises an alkyl radical X;
(B) at least one acidic, corrosion-inhibiting pigment based on polyphosphoric acid, and
(C) at least one constituent selected from the group consisting of nanoparticles and electrically conductive pigments.

2. The coating material as claimed in claim 1, wherein the radical X of (A1) is an aromatic radical having 6 to 10 carbon atoms.

3. The coating material as claimed in claim 1, wherein the radical X of (A2) is a straight-chain alkyl radical having 10 to 20 carbon atoms.

4. The coating material as claimed in claim 1, wherein the trivalent organic radical is an aliphatic radical having 3 to 6 carbon atoms.

5. The coating material as claimed in claim 1, wherein the linking functional group Z is a carboxylic ester group linked to the radicals Y and Gr in accordance with the general formula II:
>Y—O—(O═)C-Gr (II).

6. The coating material as claimed in claim 1, wherein the organic radical Gr comprises a group which can be activated with actinic radiation.

7. The coating material as claimed in claim 6, wherein the group which can be activated with actinic radiation is an olefinically unsaturated double bond.

8. The coating material as claimed in claim 1, wherein the weight ratio of (A1) to (A2) is 4:1 to 0.8:1.

9. The coating material as claimed in claim 1, wherein the acidic, corrosion-inhibiting pigment (B) is an aluminum polyphosphate.

10. The coating material as claimed in claim 1, wherein the nanoparticles (C) are inorganic nanoparticles.

11. The coating material as claimed in claim 1, wherein the electrically conductive pigment (C) is selected from the group consisting of the metal-doped oxides of tin, zinc, indium, and antimony.

12. The coating material as claimed in claim 1, wherein the coating material further comprises at least one additive (D).

13. The coating material as claimed in claim 12, wherein the additive (D) is selected from the group consisting of water, polyphosphoric acid, phosphonic acids having at least one group which can be activated with actinic radiation, acidic esters of monophosphoric acid and of at least one compound containing at least one hydroxyl group and at least one group which can be activated with actinic radiation, acidic esters of monophosphoric acid and of at least one compound containing at least one hydroxyl group and at least one group which can be activated with actinic radiation, compounds having at least one group which can be activated with actinic radiation, other than the compounds (A), driers, non-(C), organic and inorganic, colored and achromatic, optical effect, electrically conductive, magnetically shielding, and fluorescent pigments, transparent and opaque, organic and inorganic fillers, nanoparticles, oligomeric and polymeric binders, UV absorbers, light stabilizers, free-radical scavengers, photoinitiators, devolatilizers, slip additives, polymerization inhibitors, defoamers, emulsifiers and wetting agents, adhesion promoters, leveling agents, film-forming assistants, rheology control additives, and flame retardants.

14. The coating material as claimed in claim 1, wherein the coating material is a water-in-oil dispersion having a pH <5.

15. A process for preparing a coating material as claimed in claim 1, comprising mixing (A), (B) and (C) and, optionally, (D), and homogenizing the resulting mixture, wherein (D) is at least one additive.

16. A coil coating comprising the material as claimed in claim 1.

17. The coil coating as claimed in claim 16, wherein the coil coating is a primer coating.
